(19) United States
(12) Patent Application Publication
(10) Pub. No.: US 2025/0200381 A1
(43) Pub. Date: Jun. 19, 2025

(54) METHOD AND DEVICE FOR FAIR FEW-SHOT CIL

(71) Applicant: Korea Advanced Institute of Science and Technology, Daejeon (KR)

(72) Inventors: Euijong WHANG, Daejeon (KR); Jaeyoung PARK, Daejeon (KR)

(21) Appl. No.: 18/428,601

(22) Filed: Jan. 31, 2024

(30) Foreign Application Priority Data
Dec. 13, 2023 (KR) 10-2023-0180887

(51) Int. Cl. G06N 3/096

(52) U.S. Cl. CPC G06N 3/096

(57) ABSTRACT

Disclosed are a method and device for fair few-shot CIL. The method includes constructing a separate storage device by using samples of a first super class having first accuracy and samples of a second super class having second accuracy lower than the first accuracy, performing incremental learning on the separate storage device, adjusting the number of samples of the first super class and the number of samples of the second super class in the separate storage device when the results of the incremental learning satisfy a fairness criterion or when the first accuracy is lower than the second accuracy in the results of the incremental learning, and performing incremental learning in a next step on the separate storage device.

### CROSS-REFERENCES TO RELATED APPLICATION

This application is based on and claims priority under 35 U.S.C. 119 to Korean Patent Application No. 10-2023-0180887, filed on Dec. 13, 2023 in the Korean intellectual property office, the disclosure of which is herein incorporated by reference in their entirety.

### TECHNICAL FIELD

The present disclosure relates to a method and device for fair few-shot CIL.

### BACKGROUND OF THE DISCLOSURE

A classification model using machine learning shows high accuracy in several problems. In particular, in the case of image classification, a model using an artificial neural network has been rapidly developed. 1. AlexNet that won the championship in ImageNet Large Scale Visual Recognition Challenge (ILSVRC) that opened in 2012 showed a Top-5 test error rate of 15.3%. However, the model using the artificial neural network has moved on considerably, such as that ResNet that was issued in 2015 with respect to the same problem surpassed 5.1% of a human being by achieving a Top-5 test error rate of 3.57% and achieved up to 1.08% in 2021. However, even in the same dataset, a classification model in class-incremental learning (CIL) setting shows relatively low accuracy. In a CIL environment, an artificial neural network has to learn knowledge of a new class, but has also to preserve knowledge of the existing class because the type of input class is changed every incremental step.

This is also related to the stability-plasticity dilemma of an artificial neural network. In the learning of the artificial neural network, it is difficult for a model to have both stability and plasticity because it is difficult for the model to memorize new information if stability is emphasized and the model is likely to forget information that has been conventionally learnt if plasticity is emphasized. For example, if an artificial neural network is simply trained through back-propagation in an environment in which a distribution of input datasets is changed like a CIL environment, the artificial neural network forgets most of information on datasets prior to an increment. That is, although a corresponding model has high accuracy with respect to an increased class, the model has low accuracy with respect to a class that has been conventionally memorized. Such a phenomenon is called catastrophic forgetting. It is necessary to overcome the catastrophic forgetting phenomenon in order for an artificial neural network to have high accuracy in a CIL environment.

When you think about when CIL is required in the real world, there are many cases in which CIL is a few-shot. In a situation in which a CIL problem occurs, an initial model was generated by using a given dataset. However, there is a case in which a label that has not been seen so far in subsequently incoming data is continuously added. A vehicle classification model may be said to be a proper example because a new car model is subsequently released. In this case, in order to generate a model capable of additionally classifying up to a label that newly emerges, it will be necessary to collect and label data. However, in the case of a newly added class, there are many cases in which data and labels are insufficient in the real world because lots of efforts are required for the collection and labeling of data. Accordingly, it will be easy to use, in an actual situation, few-shot CIL setting in which the number of data that are used in learning with respect to a class that newly emerges is small.

In order for a machine learning model using an artificial neural network to be used in the real world, responsible AI is required. If the results of the machine learning model give damage to minorities because fairness among them is not kept, it will be difficult for the machine learning model to be used in the real world. Accordingly, in order to use the CIL model in reality, it is necessary to overcome the catastrophic forgetting phenomenon, and fair learning also needs to be an objective.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In a few-shot CIL environment using a conventional technology, as an incremental step continues, an unfair degree of a model becomes severe because the degree of forgetting is different for each small group. The reason for this is that a degree that a model forgets knowledge that was conventionally learnt is different for each small group due to different catastrophic forgetting. A model can longer memorize a class having high accuracy because the class has been sufficiently learnt, and the class has a small degree of catastrophic forgetting. In contrast, more catastrophic forgetting occurs in a class having low accuracy.

FIG. 1 is a graph illustrating the accuracy of conventional CIL. Specifically, FIG. 1 is a graph illustrating accuracy for each small group (MNIST and Fashion-MNIST) when MNIST and Fashion-MNIST datasets are learnt in a few-shot CIL environment by using LwF (Li, Z., & Hoiem, D. Learning without Forgetting, IEEE transactions on pattern analysis and machine intelligence 2017), that is, one of representative schemes for CIL. Referring to FIG. 1, an accuracy difference between small groups is increased as the incremental step continues. Accordingly, it was observed that overall accuracy equality (OAE), that is, an accuracy difference between two small groups, is also increased. Accordingly, a model needs to be generated by considering fairness because fairness becomes worse as the learning proceeds if conventional few-shot CIL in which fairness has not been considered is performed.

In order to generate a fair few-shot CIL model, it is necessary to reduce the degree of catastrophic forgetting in a small group having low accuracy because a cause of the accuracy difference is catastrophic forgetting. To this end, there is proposed a fair few-shot CIL model in a way to construct a loss function that increases distinction between small groups of a model having low accuracy by applying a regulatory scheme that is used in the existing few-shot CIL environment and to adjust the number of samples that are stored in a separate memory device for each small group by applying a memory reproduction scheme.

Embodiments of the present disclosure provide a method and device for fair few-shot CIL.

In an embodiment of the present disclosure, a method for fair few-shot class-incremental learning (CIL) of a computer device may include constructing a separate storage device by using samples of a first super class having first accuracy and samples of a second super class having second accuracy lower than the first accuracy, performing incremental learning on the separate storage device, adjusting the number of samples of the first super class and the number of samples of the second super class in the separate storage device when the results of the incremental learning satisfy a fairness criterion or when the first accuracy is lower than the second accuracy in the results of the incremental learning, and performing incremental learning in a next step on the separate storage device.

In an embodiment of the present disclosure, a computer device for fair few-shot shot class-incremental learning (CIL) may include memory and a processor connected to the memory and configured to execute at least one instruction stored in the memory. The processor is configured to construct a separate storage device by using samples of a first super class having first accuracy and samples of a second super class having second accuracy lower than the first accuracy, perform incremental learning on the separate storage device, adjust the number of samples of the first super class and the number of samples of the second super class in the separate storage device when the results of the incremental learning satisfy a fairness criterion or when the first accuracy is lower than the second accuracy in the results of the incremental learning, and perform incremental learning in a next step on the separate storage device.

In an embodiment of the present disclosure, in a computer program stored in a non-transitory computer-readable recording medium in order to execute a method for fair few-shot class-incremental learning (CIL) in a computer device, the method for fair few-shot CIL may include constructing a separate storage device by using samples of a first super class having first accuracy and samples of a second super class having second accuracy lower than the first accuracy, performing incremental learning on the separate storage device, adjusting the number of samples of the first super class and the number of samples of the second super class in the separate storage device when the results of the incremental learning satisfy a fairness criterion or the first accuracy is lower than the second accuracy in the results of the incremental learning, and performing incremental learning in a next step on the separate storage device.

The present disclosure can propose a CIL model having high performance, which overcomes the catastrophic forgetting phenomenon and also performs fair learning. Specifically, according to the present disclosure, a case having the highest accuracy can be selected while satisfying a fairness criterion. Although there is no case in which the fairness criterion is satisfied, a case in which a super class having low accuracy can be better distinguished can be selected.

### DESCRIPTION OF THE DRAWINGS

The foregoing aspects and many of the attendant advantages of this disclosure will become more readily appreciated as the same become better understood by reference to the following detailed description, when taken in conjunction with the accompanying drawings, wherein:

FIG. 1 is a graph illustrating the accuracy of conventional class-incremental learning (CIL).

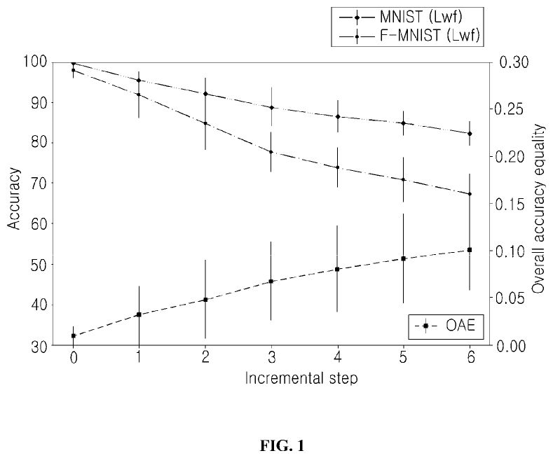

FIG. 2 is a diagram for describing an object of a triplet loss function in a characteristic space.

FIG. 3 is a graph illustrating overall accuracy equality according to the number of samples that are stored in a separate storage device for each super class.

FIG. 4 is a diagram schematically illustrating a construction of a computer device for fair few-shot CIL according to various embodiments of the present disclosure.

FIG. 5 is a diagram illustrating an algorithm for fair few-shot CIL according to various embodiments of the present disclosure.

FIG. 6 is a diagram schematically illustrating a procedure of a method for fair few-shot CIL of the computer device according to various embodiments of the present disclosure.

### DETAILED DESCRIPTION

While illustrative embodiments have been illustrated and described, it will be appreciated that various changes can be made therein without departing from the spirit and scope of the disclosure.

Hereinafter, various embodiments of the present disclosure are described with reference to the accompanying drawings.

The present scheme basically includes a “regulatory scheme” and a “memory reproduction scheme”. In the “regulatory scheme”, a fair backbone is learnt in a process prior to increment. In the “memory reproduction scheme”, a class selection algorithm that reduces the degree of forgetting of the existing weak super class having low accuracy in an incremental process and that will enter a separate storage device is proposed. Accordingly, the present disclosure proposes a framework capable of fair few-shot CIL by adjusting all work flows in the entire learning process.

### <Regulatory Scheme>

The existing regulatory research has an object of widening a distance between different labels in a characteristic space. Accordingly, (1) the characteristics of the existing class and the characteristics of a new class are less overlapped by increasing a distance between the classes in the characteristic space although the new class is entered in an incremental step. (2) a classification mode can easily perform classification by reducing a class dispersion in the characteristic space. If a cause of low accuracy of a weak super class lies in that the learning of a classification model is difficult due to a close distance between the weak super class and another class in the characteristic space by applying the first characteristic among the characteristics, the accuracy of the weak super class will be increased by adjusting the distance between the weak super class and the another class so that the distance is increased.

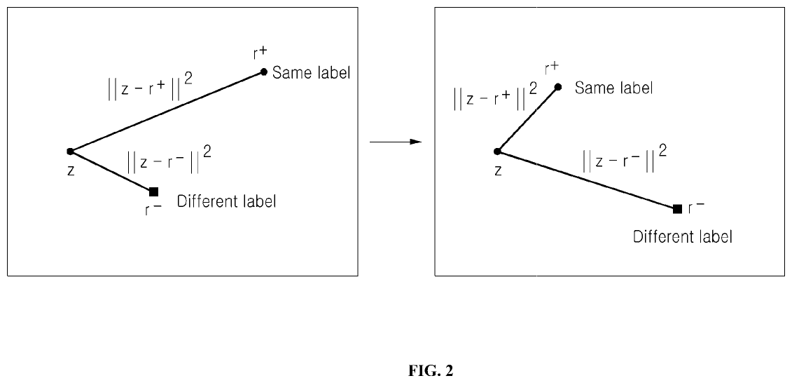

Accordingly, a regulatory loss function is designed with reference to several researches having an object of widening a distance between different labels. The loss function is designed by regulating a triplet loss function, that is, a scheme from metric learning research, with respect to a distance between labels even in few-shot CIL research. This may be understood in detail with reference to FIG. 2.

FIG. 2 is a diagram for describing an object of a triplet loss function in a characteristic space.

Referring to FIG. 2, with respect to a characteristic vector z of each point within a mini-batch, r⁺ means a point having the same label within the same mini-batch, and r⁻ means a point having a different label. In FIG. 2, a figure on the left side means a situation in which a distance (∥z−r⁺∥²) from the point having the same label is more distant than a distance (∥z−r⁻∥²) between different labels. A figure on the right side means a situation opposite the situation in the figure on the left side. That is, the left situation in FIG. 2 needs to be changed into the right situation, but adjustment is no longer required if the left situation has already been changed into the right situation. To this end, a loss function is designed as in Equation 1, and is added to the existing cross-entropy loss function. A model is designed to perform learning more effectively and perform fair few-shot CIL by adjusting a distance between classes through the designed loss function and through proper regulations.

$${ℒ}_{ip} = max ( \frac{{‖ z - {r}^{+} ‖}^{2} - {‖ z - {r}^{-} ‖}^{2}}{{‖ z - {r}^{+} ‖}^{2} + {‖ z - {r}^{-} ‖}^{2}} , 0 ) \qquad ( 1 )$$

### <Memory Reproduction Scheme>

A separate storage device cannot store a sufficiently large number of samples due to its limited capacity. Furthermore, in order to add a sample to the separate storage device, the existing sample needs to be removed from the separate storage device. Furthermore, in general, the accuracy of a model is increased when the number of learning data is increased, and is also decreased when the number of learning data is reduced. That is, if many samples of one super class are stored, the samples of another super class will be less stored. Accordingly, an accuracy difference between two super classes may be increased or decreased by adjusting the number of samples.

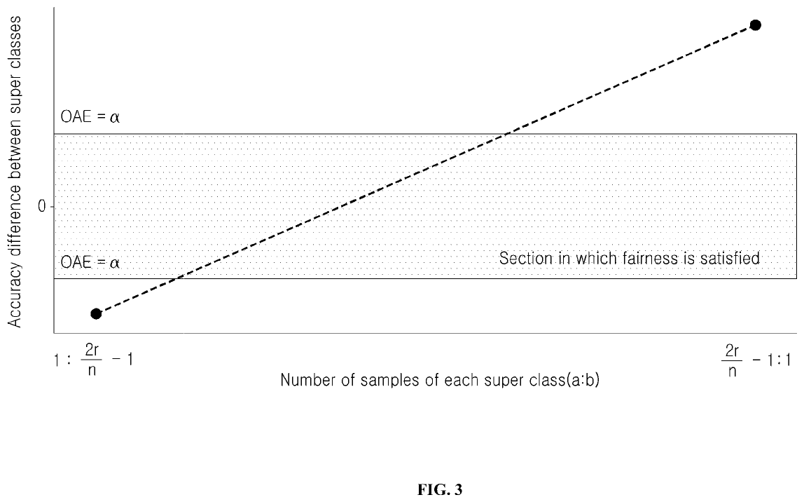

FIG. 3 is a graph illustrating overall accuracy equality according to the number of samples that are stored in a separate storage device for each super class.

Referring to FIG. 3, if an accuracy difference between super classes is calculated while changing the number of samples that will be stored in the separate storage device for each super class on the basis of the above hypothesis, a section that satisfies fairness for each number of samples may be up and down on the basis of a point at which the accuracy difference between the super classes is 0. Furthermore, if a specific super class occupies most of samples that will be stored in the separate storage device, it may be predicted that the overall accuracy equality will exceed a, that is, a fairness target, because the accuracy of a super class in which a small number of samples have been stored is reduced in another incremental learning process (white area in FIG. 3). Furthermore, the range of the fairness target that is satisfied would have leaned toward the side on which more super classes “b” are stored because the super class “b” is more inaccurate than a super class “a” conventionally.

Accordingly, the present disclosure provides a method and device for fair few-shot class-incremental learning (CIL).

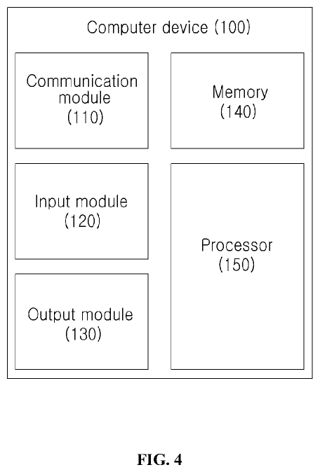

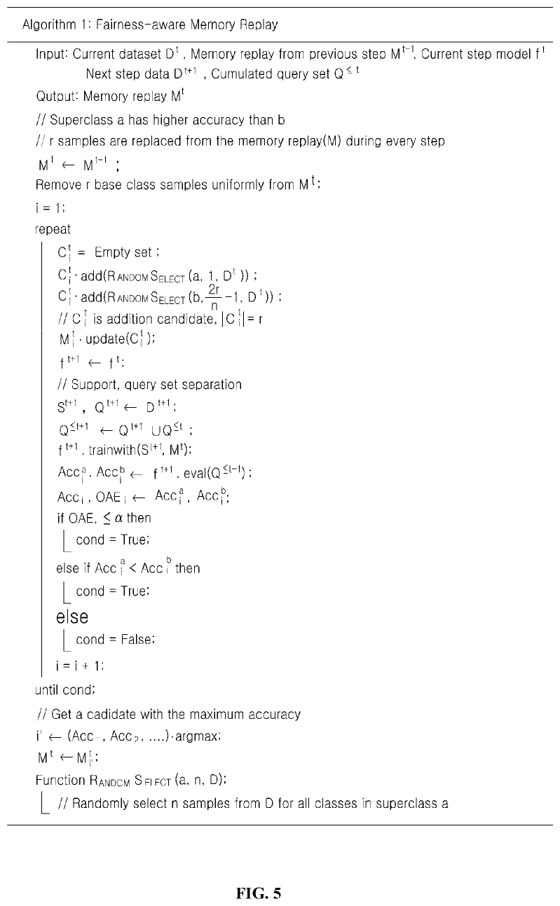

FIG. 4 is a diagram schematically illustrating a construction of a computer device 100 for fair few-shot CIL according to various embodiments of the present disclosure. FIG. 5 is a diagram illustrating an algorithm for fair few-shot CIL according to various embodiments of the present disclosure.

Referring to FIG. 4, the computer device 100 is for fair few-shot CIL, and may include at least one of a communication module 110, an input module 120, an output module 130, memory 140, or a processor 150. In some embodiments, at least one of the components of the computer device 100 may be omitted, and at least another component may be added to the computer device 100. In some embodiments, at least two of the components of the computer device 100 may be implemented as one integrated circuit.

The communication module 110 may perform communication with an external device in the computer device 100. The communication module 110 may establish a communication channel between the computer device 100 and the external device, and may perform communication with the external device through the communication channel. In this case, the external device may include at least one of another computer device, a base station, or a server. The communication module 110 may include at least one of a wired communication module or a wireless communication module. The wired communication module may be connected to the external device through wires, and may communicate with the external device through wires. The wireless communication module may include at least one of a short-distance communication module or a long-distance communication module. The short-distance communication module may communicate with the external device by using a short-distance communication method. For example, the short-distance communication method may include at least one of Bluetooth, Wi-Fi direct, or infrared data association (IrDA). The long-distance communication module may communicate with the external device by using a long-distance communication method. In this case, the long-distance communication module may communicate with the external device over a network. For example, the network may include at least one of a cellular network, the Internet, or a computer network, such as a local area network (LAN) or a wide area network (WAN).

The input module 120 may input a signal to be used in at least one component of the computer device 100. The input module 120 may be configured to detect a signal that is directly input by a user or to generate a signal by detecting a surrounding change. For example, the input module 120 may include at least one of a mouse, a keypad, a microphone, or a sensing module having at least one sensor. In some embodiments, the input module 120 may include at least one of touch circuitry configured to detect a touch or a sensor circuit configured to measure the strength of a force that is generated by a touch.

The output module 130 may output information to the outside of the computer device 100. The output module 130 may include at least one of a display module configured to visually output information or an audio output module capable of outputting information as an audio signal. For example, the audio output module may include at least one of a speaker or a receiver.

The memory 140 may store various data that are used by at least one component of the computer device 100. For example, the memory 140 may include at least one of volatile memory or nonvolatile memory. The data may include at least one program and input data or output data that are related to the at least one program. The program may be stored in the memory 140 as software including at least one instruction, and may include at least one of an operating system, middleware, or an application.

The processor 150 may control at least one component of the computer device 100 by executing a program of the memory 140. To this end, the processor 150 may perform data processing or an operation. In this case, the processor 150 may execute an instruction stored in the memory 140.

According to various embodiments, the processor 150 may perform fair few-shot CIL. In this case, the processor 150 may perform the fair few-shot CIL based an algorithm illustrated in FIG. 5. Specifically, the processor 150 may construct a separate storage device by using the samples of a first super class “a” having first accuracy and the samples of a second super class “b” having second accuracy. In this case, the first accuracy may be higher than the second accuracy. In other words, the second accuracy may be lower than the first accuracy. In this case, the processor 150 may store the samples of the second super class “b” by a maximum number that is permitted with respect to the second super class “b” in the separate storage device. Furthermore, the processor 150 may perform incremental learning on the separate storage device.

According to various embodiments, when a fairness criterion is satisfied or the first accuracy is lower than the second accuracy as the results of the incremental learning, the processor 150 may adjust the number of samples of the first super class “a” and the number of samples of the second super class “b” in the separate storage device. Furthermore, the processor 150 may perform incremental learning in a next step on the separate storage device. In this case, the processor 150 may return to adjusting the number of samples of the first super class “a” and the number of samples of the second super class “b”. Accordingly, adjusting the number of samples of the first super class “a” and the number of samples of the second super class “b” and performs the incremental learning in a next step may be repeated until the results of the incremental learning does not satisfy the fairness criterion and the first accuracy is higher than the second accuracy as the results of the incremental learning. As a result, the processor 150 may select a separate storage device having the number of samples of the first super class “a” and the number of samples of the second super class “b” when overall accuracy is the highest as the results of the incremental learning.

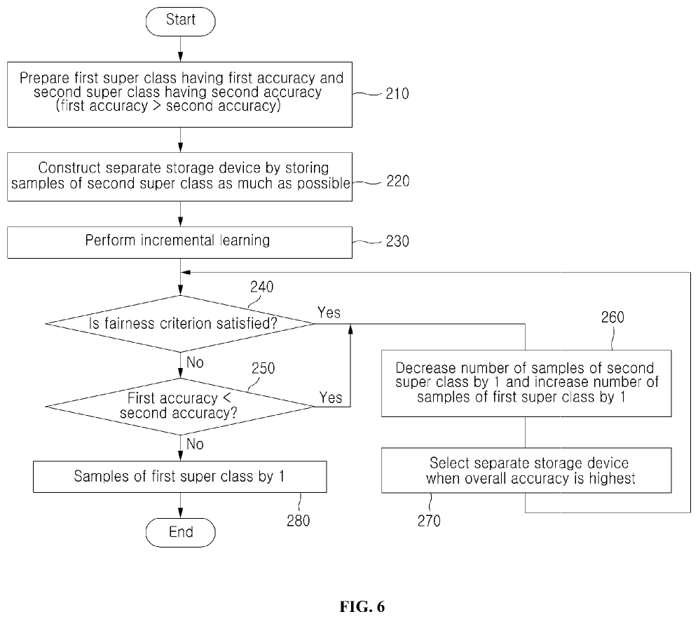

FIG. 6 is a diagram schematically illustrating a procedure of a method for fair few-shot CIL of the computer device 100 according to various embodiments of the present disclosure.

Referring to FIG. 6, in step 210, the computer device 100 may prepare a first super class “a” having first accuracy and a second super class “b” having second accuracy. In this case, the first accuracy may be higher than the second accuracy. In other words, the second accuracy may be lower than the first accuracy. In this case, the processor 150 may obtain the first super class “a” and the second super class “b” from data that are received through the communication module 110 or that are input through the input module 120.

Next, in step 220, the computer device 100 may construct a separate storage device by using the samples of the first super class “a” and the samples of the second super class “b”. In this case, the processor 150 may store the samples of the second super class “b” by a maximum number that is permitted with respect to the second super class “b” in the separate storage device, and may store the samples of the first super class “a” with respect to the remainder. Thereafter, in step 230, the computer device 100 may perform incremental learning on the separate storage device. In this case, the processor 150 may perform the incremental learning in the first step. In such incremental learning, the first accuracy and the second accuracy may be changed.

Next, in step 240, the computer device 100 may determine whether the results of the incremental learning satisfies a fairness criterion. In this case, the fairness criterion may indicate a point corresponding to x=1:2r/n−1 in FIG. 3. In this case, when it is determined that the fairness criterion is not satisfied in step 240, in step 250, the computer device 100 may determine whether the first accuracy is lower than the second accuracy in the results of the incremental learning.

Subsequently, when it is determined that the fairness criterion is satisfied in step 240 or it is determined that the first accuracy is lower than the second accuracy in step 250, the computer device 100 may proceed to step 260. In step 260, the computer device 100 may adjust the number of samples of the first super class “a” and the number of samples of the second super class “b” in the separate storage device. In this case, the processor 150 may decrease the number of samples of the second super class “b” by 1, and may increase the number of samples of the first super class “a” by 1. Thereafter, in step 270, the computer device 100 may perform incremental learning on the separate storage device. In this case, the processor 150 may perform the incremental learning in a next step. In such incremental learning, the first accuracy and the second accuracy may be changed. Thereafter, the processor 150 may return to step 240.

In this way, the computer device 100 may repeat at least one of step 240, step 250, step 260, and step 270 until when it is determined that the fairness criterion is not satisfied in step 240 and when it is determined that the first accuracy is not lower than the second accuracy in step 250.

In an embodiment, when the results of the incremental learning in the first step satisfies the fairness criterion in step 240, if the results of incremental learning in an arbitrary next step does not satisfy the fairness criterion in subsequent step 240, it may not be necessary to perform incremental learning on the remaining steps. The reason for this is that it may be difficult for the results of incremental learning in the remaining steps to satisfy the fairness criterion.

In another embodiment, when the results of the incremental learning do not satisfy the fairness criterion in step 240 and the first accuracy is lower than the second accuracy in step 250, if it is difficult for the results of incremental learning in an arbitrary next step to satisfy the fairness criterion in subsequent step 240 and the first accuracy is not lower than the second accuracy in the results of incremental learning in arbitrary another step in subsequent step 250, it may not be necessary to perform incremental learning on the remaining steps. The reason for this is that overall accuracy equality may be a minimum because the samples of the second super class “b” have already been stored by a maximum number that is permitted with respect to the second super class “b” in the separate storage device in step 220.

Finally, when it is determined that the fairness criterion is not satisfied in step 240 and when it is determined that the first accuracy is not lower than the second accuracy in step 250, the computer device 100 may proceed to step 280. In step 280, the computer device 100 may select a separate storage device when overall accuracy is the highest in the results of the incremental learning. That is, the processor 150 may select the separate storage device having the number of samples of the first super class “a” and the number of samples of the second super class “b” when overall accuracy is the highest in the results of the incremental learning.

Accordingly, the present disclosure can overcome the catastrophic forgetting phenomenon and also present a class-incremental learning (CIL) model having high performance for fair learning. Specifically, the present disclosure may select a case having the highest accuracy while satisfying the fairness criterion. Although a case that satisfies the fairness criterion is not present, a case in which a super class having low accuracy can be better distinguished may be selected.

As described above, the present disclosure has presented the framework for fair few-shot CIL. Several numbers of cases that satisfy the fairness criterion are checked by using memory reappearance in an incremental step. A model having the best performance may be selected among models that satisfy a given fairness criterion by selecting the number of cases having the highest accuracy, among the several numbers of cases. Although the number of cases that satisfy the fairness criterion is not present, a model can better distinguish between super classes having low accuracy by learning a fair backbone through regulations in a step prior to increment. Accordingly, the trained model can present an option that satisfies the fairness criterion.

Furthermore, according to the present disclosure, a model-based scheme that is used for different fairness or CIL regardless of the type of classification model (i.e., model-agnostic) can be constructed in parallel. The number of samples to be stored is merely determined when the samples are stored in a separate storage device, and which sample will be stored is not designated. Accordingly, the present disclosure may be combined with a sample selection scheme using priority, such as the existing iCarl (Rebuffi S. A., et al., icarl: Incremental classifier and representation learning. CVPR 2017) or DER (Yan et al., Der: Dynamically expandable representation for class incremental learning. CVPR 2021).

Such fair few-shot CIL can be variously used even in the real world. In particular, it is considered that the fair few-shot CIL will be effective in a face recognition field. An office access management system through a face recognition model may be considered. This case may be said to be a case corresponding to CIL in which classes that need to be classified are changed because the number of people in an office may be changed due to joining a company and leaving the company. In this case, as a result of checking analytical statistics through a corresponding model, the use of the model may be difficult due to a fairness problem if the accuracy of women is lower than that of men, in particular. In particular, the above case is a scenario that is highly likely to happen. The reason for this is that in a common face recognition scenario, face recognition accuracy of women is lower than that of men.

In other words, the present disclosure provides the method and device for fair few-shot CIL.

In an embodiment of the present disclosure, a method for fair few-shot CIL by the computer device 100 may include a step of constructing a separate storage device by using the samples of a first super class “a” having first accuracy and the samples of a second super class “b” having second accuracy lower than the first accuracy (step 220), a step of performing incremental learning on the separate storage device (step 230), a step of adjusting the number of samples of the first super class “a” and the number of samples of the second super class “b” in the separate storage device (step 260) when the results of the incremental learning satisfy a fairness criterion (step 240) or the first accuracy is lower than the second accuracy in the results of the incremental learning (step 250), and a step of performing incremental learning in a next step on the separate storage device (step 270).

In an embodiment of the present disclosure, in the step of constructing the separate storage device (step 220), the samples of the second super class “b” may be stored by a maximum number that is permitted with respect to the second super class “b” in the separate storage device.

In an embodiment of the present disclosure, the method for fair few-shot CIL may return to a step of adjusting the number of samples of the first super class “a” and the number of samples of the second super class “b” in the separate storage device (step 260) when the results of the incremental learning satisfy the fairness criterion (step 240) or the first accuracy is lower than the second accuracy in the results of the incremental learning (step 250) after performing the incremental learning in the next step (step 270).

In an embodiment of the present disclosure, when the results of the incremental learning satisfy the fairness criterion (step 240) or the first accuracy is lower than the second accuracy in the results of the incremental learning (step 250), the step of adjusting the number of samples of the first super class “a” and the number of samples of the second super class “b” in the separate storage device (step 260) and the step of performing the incremental learning in the next step (step 270) may be repeated until the results of the incremental learning do not satisfy the fairness criterion and the first accuracy is higher than the second accuracy in the results of the incremental learning.

In an embodiment of the present disclosure, the method for fair few-shot CIL may further include a step of selecting a separate storage device having the number of samples of the first super class “a” and the number of samples of the second super class “b” when overall accuracy is the highest in the results of the incremental learning (step 280).

In an embodiment of the present disclosure, the computer device 100 for fair few-shot CIL includes the memory 140 and the processor 150 connected to the memory 140 and configured to execute at least one instruction stored in the memory 140. The processor 150 may be configured to construct a separate storage device by using the samples of a first super class “a” having first accuracy and the samples of a second super class “b” having second accuracy lower than the first accuracy, perform incremental learning on the separate storage device, adjust the number of samples of the first super class “a” and the number of samples of the second super class “b” in the separate storage device when the results of the incremental learning satisfy a fairness criterion or the first accuracy is lower than the second accuracy in the results of the incremental learning, and perform incremental learning in a next step on the separate storage device.

In an embodiment of the present disclosure, the processor 150 may be configured to store the samples of the second super class “b” by a maximum number that is permitted with respect to the second super class “b” in the separate storage device.

In an embodiment of the present disclosure, the processor 150 may be configured to return and adjust the number of samples of the first super class “a” and the number of samples of the second super class “b” after performing incremental learning in a next step.

In an embodiment of the present disclosure, adjusting the number of samples of the first super class “a” and the number of samples of the second super class “b” and performing the incremental learning in the next step may be repeated until when the results of the incremental learning do not satisfy the fairness criterion and the first accuracy is higher than the second accuracy in the results of the incremental learning.

In an embodiment of the present disclosure, the processor 150 may be configured to select a separate storage device having the number of samples of the first super class “a” and the number of samples of the second super class “b” when overall accuracy is the highest in the results of the incremental learning.

In an embodiment of the present disclosure, in a computer program that has been stored in a non-transitory computer-readable recording medium in order to execute the method for fair few-shot CIL in the computer device 100, the method for fair few-shot CIL may include steps of constructing a separate storage device by using the samples of a first super class “a” having first accuracy and the samples of a second super class “b” having second accuracy lower than the first accuracy, performing incremental learning on the separate storage device, adjusting the number of samples of the first super class “a” and the number of samples of the second super class “b” in the separate storage device when the results of the incremental learning satisfy a fairness criterion or the first accuracy is lower than the second accuracy in the results of the incremental learning, and performing incremental learning in a next step on the separate storage device.

The aforementioned device may be implemented as a hardware component, a software component, and/or a combination of a hardware component and a software component. For example, the device and component described in the embodiments may be implemented by using one or more general-purpose computers or special-purpose computers, such as a processor, a controller, an arithmetic logic unit (ALU), a digital signal processor, a microcomputer, a field programmable gate array (FPGA), a programmable logic unit (PLU), a microprocessor, or any other device capable of executing or responding to an instruction. The processing device may perform an operating system (OS) and one or more software applications that are executed on the OS. Furthermore, the processing device may access, store, manipulate, process, and generate data in response to the execution of software. For convenience of understanding, one processing device has been illustrated as being used, but a person having ordinary knowledge in the art may understand that the processing device may include a plurality of processing elements and/or a plurality of types of processing elements. For example, the processing device may include a plurality of processors or one processor and one controller. Furthermore, another processing configuration, such as a parallel processor, is also possible.

Software may include a computer program, a code, an instruction or a combination of one or more of them, and may configure a processing device so that the processing device operates as desired or may instruct the processing devices independently or collectively. The software and/or the data may be embodied in any type of machine, a component, a physical device, or a computer storage medium or device in order to be interpreted by the processing device or to provide an instruction or data to the processing device. The software may be distributed to computer systems that are connected over a network, and may be stored or executed in a distributed manner. The software and the data may be stored in one or more computer-readable recording media.

The method according to various embodiments may be implemented in the form of a program instruction executable by various computer means, and may be stored in a computer-readable medium. In this case, the medium may continue to store a computer-executable program, or may temporarily store the computer-executable program for execution or download. Furthermore, the medium may be various recording means or storage means having a form in which a single piece of hardware or several pieces of hardware have been combined, and is not limited to a medium that is directly connected to any computer system and may be present by being distributed on a network. Examples of the medium may be magnetic media such as a hard disk, a floppy disk, and a magnetic tape, optical media such as CD-ROM and a DVD, magneto-optical media such as a floptical disk, and may be constructed to store computer instructions, such as, ROM, RAM, and flash memory. Furthermore, examples of another medium may include an app store in which apps are distributed, a site in which other various pieces of software are supplied or distributed, and recording media and/or storage media that are managed in a server.

Various embodiments of this document and the terms used in the embodiments are not intended to limit the technology described in this document to a specific embodiment, but should be construed as including various changes, equivalents and/or alternatives of a corresponding embodiment. In relation to the description of the drawings, similar reference numerals may be used in similar components. An expression of the singular number may include an expression of the plural number unless clearly defined otherwise in the context. In this document, an expression, such as “A or B”, “at least one of A and/or B”, “A, B, or C” or “at least one of A, B and/or C”, may include all of possible combinations of items listed together. Expressions, such as “a first,” “a second,” “the first”, and “the second”, may modify corresponding components regardless of its sequence or importance, and are used to only distinguish one component from another component and do not limit corresponding components. When it is described that one (e.g., a first) component is “(functionally or communicatively) connected to” or “coupled with” the other (e.g., a second) component, one component may be directly connected to another component or may be connected to another component through another component (e.g., a third component).

According to various embodiments, each (e.g., a module or a program) of the aforementioned components may include a single entity or a plurality of entities. According to various embodiments, one or more of the aforementioned components or steps may be omitted or one or more other components or steps may be added. Alternatively or additionally, a plurality of components (e.g., modules or programs) may be integrated into a single component. In such a case, the integrated component may identically or similarly perform a function performed by a corresponding one of the plurality of components before one or more functions of each of the plurality of components are integrated. According to various embodiments, steps performed by a module, a program or another component may be executed sequentially, in parallel, iteratively or heuristically, or one or more of the steps may be executed in different order or may be omitted, or one or more other steps may be added.

The embodiments of the disclosure in which an exclusive property or privilege is claimed are defined as follows:

1. A method for fair few-shot class-incremental learning (CIL) of a computer device, the method comprising:
constructing a separate storage device by using samples of a first super class having first accuracy and samples of a second super class having second accuracy lower than the first accuracy;
performing incremental learning on the separate storage device;
adjusting a number of samples of the first super class and a number of samples of the second super class in the separate storage device when results of the incremental learning satisfy a fairness criterion or when the first accuracy is lower than the second accuracy in the results of the incremental learning; and
performing incremental learning in a next step on the separate storage device.

2. The method of claim 1, wherein the constructing of the separate storage device comprises storing the samples of the second super class by a maximum number that is permitted with respect to the second super class in the separate storage device.

3. The method of claim 1, further comprising returning to adjusting the number of samples of the first super class and the number of samples of the second super class after performing the incremental learning in the next step.

4. The method of claim 3, wherein the adjusting of the number of samples of the first super class and the number of samples of the second super class and performing the incremental learning in the next step are repeated when the results of the incremental learning do not satisfy the fairness criterion and the first accuracy is higher than the second accuracy in the results of the incremental learning.

5. The method of claim 4, further comprising selecting a separate storage device having the number of samples of the first super class and the number of samples of the second super class when overall accuracy is a highest in the results of the incremental learning.

6. A computer device for fair few-shot shot class-incremental learning (CIL), comprising:
memory; and
a processor connected to the memory and configured to execute at least one instruction stored in the memory,
wherein the processor is configured to
construct a separate storage device by using samples of a first super class having first accuracy and samples of a second super class having second accuracy lower than the first accuracy,
perform incremental learning on the separate storage device,
adjust a number of samples of the first super class and a number of samples of the second super class in the separate storage device when results of the incremental learning satisfy a fairness criterion or when the first accuracy is lower than the second accuracy in the results of the incremental learning, and
perform incremental learning in a next step on the separate storage device.

7. The computer device of claim 6, wherein the processor is configured to store the samples of the second super class by a maximum number that is permitted with respect to the second super class in the separate storage device.

8. The computer device of claim 6, wherein:
the processor is configured to return to adjusting the number of samples of the first super class and the number of samples of the second super class after performing the incremental learning in the next step, and
adjusting the number of samples of the first super class and the number of samples of the second super class and performing the incremental learning in the next step are repeated when the results of the incremental learning do not satisfy the fairness criterion and the first accuracy is higher than the second accuracy in the results of the incremental learning.

9. The computer device of claim 6, wherein the processor is configured to select a separate storage device having the number of samples of the first super class and the number of samples of the second super class when overall accuracy is a highest in the results of the incremental learning.

10. A non-transitory computer-readable recording medium storing at least one program to execute a method for fair few-shot class-incremental learning (CIL) in a computer device, wherein the method for fair few-shot CIL comprises:
constructing a separate storage device by using samples of a first super class having first accuracy and samples of a second super class having second accuracy lower than the first accuracy;
performing incremental learning on the separate storage device;
adjusting a number of samples of the first super class and a number of samples of the second super class in the separate storage device when results of the incremental learning satisfy a fairness criterion or the first accuracy is lower than the second accuracy in the results of the incremental learning; and
performing incremental learning in a next step on the separate storage device.
